(19) United States
(12) Patent Application Publication
(10) Pub. No.: US 2026/0016135 A1
(43) Pub. Date: Jan. 15, 2026

(54) ELLIPTICAL LIGHT GUIDE AND FUNNEL OF A BLADE JOINED BY A BRIDGE

(71) Applicant: Valeo Vision, Bobigny (FR)

(72) Inventors: Gustavo Gomez, Queretaro (MX); Maxime Laminette, Queretaro (MX); Brant Potter, Troy, MI (US)

(21) Appl. No.: 18/772,419

(22) Filed: Jul. 15, 2024

(51) Int. Cl. F21S 41/24

(52) U.S. Cl. CPC F21S 41/24

(57) ABSTRACT

A light system comprising: a light guiding system comprising: a light guide configured to receive light and direct the light along a length, a width, or both of the light guide; a blade configured to receive all or a portion of the light from the light guide; and a bridge that connects the light guide and the blade together.

### FIELD

The present teachings relate to a light guide and more specifically a light guide integrally connected to a blade with a funnel by a bridge.

### BACKGROUND

Vehicles include many different types of lights. Some types of vehicle lights around a vehicle are dome lights, spot lights, panel lights, accent lights, instrument lights, exterior lights, daytime running lights, or the like. Each of these lights illuminate some portion inside or outside of a vehicle. These lights may illuminate a region inside of or around a vehicle. These lights may provide differing amounts of lights. For example, some located may be very well lit whole other locations may have very little light.

Thus, there is a need for a light system that gathers light and directs light to a region of interest. There is a need for single piece light guide and blade. There is a need for a light blade that gathers light from the light guide. It would be desirable to have a light guide and light blade that are complementary in shape so that light is directed from the light guide into the blade.

### SUMMARY

The present teachings provide: a light system comprising: a light guiding system comprising: a light guide configured to receive light and direct the light along a length, a width, or both of the light guide; a blade configured to receive all or a portion of the light from the light guide; and a bridge that connects the light guide and the blade together.

The present teachings provide: a light system comprising: a light guiding system comprising: a light guide configured to receive light and direct the light therethrough; a blade configured to receive all or a portion of the light extending from the light guide, the blade comprising: one or more funnels that extend outward from the blade to collect the light from the light guide; and a bridge that connects the light guide to the bridge.

The present teachings provide: a light system comprising: a light guiding system comprising: a light guide configured to receive light and direct the light therethrough; a blade configured to receive all or a portion of the light extending from the light guide, the blade comprising: a first funnel on a first side of the blade that extend outward from the blade to collect the light from the light guide, and a second funnel on a second side of the blade that extends outward from the blade away from the first funnel to collect the light from the light guide; and a bridge that connects the light guide to the bridge.

The present teachings provide a light system that gathers light and directs light to a region of interest. The present teachings provide single piece light guide and blade. The present teachings provide a light blade that gathers light from the light guide. The present teachings provide a light guide and light blade that are complementary in shape so that light is directed from the light guide into the blade.

### BRIEF DESCRIPTION OF THE DRAWINGS

FIG. 1 is a side view of a vehicle.

FIG. 2 is a front view of a light system including a light guiding system.

FIG. 3A is an isometric view of a light guiding system.

FIG. 3B is a cross-sectional view of the light guiding system of FIG. 3A along line IIIB-IIIB.

FIG. 4A is an isometric view of light guiding system.

FIG. 4B is a cross-sectional view of the light guiding system of FIG. 4A along line IVB-IVB.

FIG. 5 is an isometric view of a light guiding system.

FIG. 6 is an isometric view of a light guiding system.

FIG. 7 illustrates light distribution by the light guiding system.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings relate to a light system. The light system is located within a vehicle. Preferably, the light system is part of a vehicle such as a car, motorcycle, bus, truck, semi-truck, SUV, XUV, four-wheeler, dirt bike, tractor, combine, heavy equipment, farm equipment, industrial equipment, commercial equipment, or a combination thereof. The light system may project light into an interior of the vehicle.

The light system may direct some light directly at internal components or an exterior of a vehicle. The light system may directly illuminate a component, indirectly illuminate a component, or both. The light system may be integrated into an article of manufacture (e.g., an internal component or an external light system). The light system may be partially located within an article of manufacture (e.g., a component) and partially extend out of the article of manufacture. The light system may be embedded in a component and have a surface that is exposed so that light extends out of the surface. The light system may be connected to an article of manufacture. The light system may be an assembly. The light system may be a sealed light system that is integrated into a component of a vehicle. The light system may be a sub-assembly that is included in a larger light system. The light system may be integrated into another light system and may function to be part of the light system. The light system may project light out of a component of the vehicle. The light system may include multiple different lights or light sub-systems that each provide a different function, color, or both. The light systems may be multiple light systems or light sources stacked one above the other, side by side, within different planes, within a same plane and projecting in different direction, integrated into a single light system, or a combination thereof. The light system may have multiple smaller light systems or light sources. The light systems may be covered by one or more outer lenses or may be free of an outer lens. The light system may include one or more lights that direct light into a light guide and the light guide may distribute the light. The light system and the light guide may provide light to one or more articles of manufacture.

The light system may project light onto or out of an article of manufacture of a vehicle. The light system projects a light onto some article of manufacture such as an interior component of the vehicle. For example, the light system may project onto or out of a door handle, window switches, cup holder, floor, door, arm rest, back seat, console, glove box, dashboard, foot well, quarter panel, headlight, hood, door, bumper, or a combination thereof. The article of manufacture may be any component of a vehicle.

The light sources function to produce light, direct light onto one or more articles of manufacture, direct light into a light guide, direct light through a light guiding system, or a combination thereof. The light source may be a device or a plurality of devices that create light and the light extends outward from the light source. The light source may produce a high beam, a low beam, a blending beam, a daytime running light, a warning light, a communication, ornamentation, a signal, a decoration, or a combination thereof. The light sources may have different functions. The light source may comprise a plurality of lights or may be a single light source within a set of light sources. The plurality of lights may be in one set or group of light sources. The light source may be a single light that projects light. In another example, a light source may direct light in a first direction. The light sources may direct light in a first direction. The light sources may include one or more lights or a plurality of lights. When multiple light sources are present one or more lights may be turned on depending on the color, intensity, or both desired by an occupant.

The light sources may be any type of lighting device that produces light such as an incandescent bulb, fluorescent light, compact fluorescent lamp, halogen lamp, light emitting diode (LED), high intensity discharge lamps (HID); halogen lights, xenon lights, a laser diode, phosphorous bulb, or a combination thereof. The light source may be a single lamp or bulb. Preferably, the light source is part of a set of light sources that includes a plurality of lamps, bulbs, diodes, or a combination thereof. The light source may be part of a set of light sources that includes 1 or more, 2 or more, 3 or more, 4 or more, 5 more, 7 or more, 9 or more, or 11 or more lights that produce light and combine together to form the light extending from the light system. The sets of light sources may include 20 or less, 18 or less, 16 or less, or 14 or less lights that produce light (e.g., each set may include 8 light sources or alternatively all of the sets when combined together may include 8 light sources or 2 light sources). For example, the set of light sources may be the contents of a single printed circuit board that perform a same lighting function and the set of light sources may be 8 lights. The number of light sources in a part of the light may dependent upon a size of the region to be illuminated, a size of an area to be illuminated, a size of a light guide, a length of a light guide, a radius of a light guide, a distance between the light guide and a component to be illuminated, a width of a light guide, or a combination thereof. Thus, the light source may be one or more lights, two or more lights, or three or more lights. The light source may be static. The light sources may be free of movement. The light source may be fixed. The light sources may be static within the light system. The light sources may be fixed and the light from the light source may be moved, bent, directed, or a combination thereof by optical elements, textured portions, micro-optics, optics, light guides, bridges, blades, reflectors, or a combination thereof (e.g., optics). Each device (e.g., light or LED) of the light source may be turned on and off individually. All of the light sources may be a same color or provide a same color light. For example, all of the lights may be white or non-colored light. All of the light sources may be a single-color light source. The light source (e.g., one or more lights) may be located proximate to a light guiding system.

The light guiding system functions to receive light, guide light into a light guide, guide light into a blade, guide light through a bridge, or combination thereof. The light guiding system may reflect light, funnel light, block some light, permit light to only exit into a bridge and/or blade, guide light along a longitudinal axis, or a combination thereof. The light guiding system may house all or a portion of a light source. The light guiding system may be located adjacent to a light source. A portion of the light guiding system may taper towards a light source. The light guiding system may mix light so that the light is internally reflected. The light guiding system may have a homogeneous light distribution. The light guiding system may guide some or all of the light from the light source into the light guide. The light guiding system may be directly connected to a light guide, a bridge, or a unitary part of the light guide. The light guiding system may be made of or include metal, plastic, opaque material, transparent material, a polymer, acrylic, polycarbonate, polyvinyl chloride, polypropylene, polystyrene, polyethylene, or a combination thereof. The light guiding system may be made of a same or similar material as a lens or other components of the light system. The light guiding system may guide light along the longitudinal axis and then prevent light from extending into regions of the light outside of the light guiding system. The light guiding system may extend around an end of the light system. The light guiding system may allow some light into the light guide while blocking other light from extending outside of the light guide. The light guiding system may include a light guide, bridge, blade, funnel, recess, prism, curved region, offset funnel, or a combination thereof.

The light guide functions to direct light along a longitudinal axis of the light guide and then outward from the light guide. The light guide may have internal reflections that allow light to extend along the longitudinal axis. The light guide may have optics that allow and/or facilitate some or all of the light to exit the light guide. The light guide may spread light. The light guide may distribute a homogeneous distribution, amount, intensity, or a combination thereof of light along a length, a width, or both (e.g., an area) of an article of manufacture, into a bridge, into a blade, or a combination thereof. For example, the distribution, amount, and/or intensity may be how light is spread across an article of manufacture such that the light on or within the article of manufacture is free of hot spots, spots free of light, or both, and an intensity of light on the article of manufacture is substantially the same when measured at any point on the article of manufacture. The light guide may prevent a single focus of light, a hot spot, a line of light, or a combination thereof. The light guide may spread light, translate light along the light guide, direct light substantially out of one side (or direction) from the light guide, (e.g., 50% or more, 60% or more of the total amount of light), or a combination thereof. The light guide may have a cross-sectional shape that is circular, elliptical, oval, direction centric, or a combination thereof. The light guide may have a shape so that light is directed along the longitudinal axis and then one side of the light guide assists in breaking total internal reflection to direct light out of a second side. The light guide may be shaped to guide a majority (50% or more, 60% or more, or 70% or more) of light in one direction (e.g., a primary direction). The light guide may have a shape so that the light collimates light in a predetermined direction. The light guide includes a first side with optics (e.g., a recess and prism) and a second side that is connected to or located adjacent to a bridge. The light guide may extend a distance (e.g., a length). A distance between a third side and a fourth side may be a height (e.g., top and bottom). A distance between the first side and the second side may be a width (e.g., left to right).

The height may be a minor direction of the light guide. The heights may be a thickness (e.g. a cross-sectional thickness) of the light guide in a minor direction. The heights may be substantially uniform between the ends (e.g., width) of the light guide. The height may have a greatest length at the center of the light guide. The height may reduce to a point at the ends. The heights may be a distance between the upper surface and the lower surface. The height may be a distance between a center of the upper surface and a center of the lower surface. The height may be greatest at the center between the upper surface and the center of the lower surface. The height may reduce as the upper surface approaches the lower surface at the ends. The height may be smallest at the ends. The height outside of the center may be smaller than a total height (e.g., a height from a center of the upper surface and an ends at of the lower surface). The height may assist in spreading light, disbursing light within the light guide, reflect light within the light guide, or a combination thereof. The height of the light guide may assist in reflecting light internally and then directing through towards a blade. The height may project light lengthwise and widthwise so that a light may be projected along the length to cover the length and out of the width so that light covers an article of manufacture and/or a predetermined region with light.

The length of the light guide functions to distribute light along a length of an article of manufacture and/or spread light out into a length of a blade. The length of the light guide may substantially mirror a length of the article of manufacture or a length that is desired to be illuminated. The length of the light guide may be about 1 cm or more, about 5 cm or more, about 10 cm or more, about 15 cm or more, about 20 cm or more, about 25 cm or more, or about 30 cm or more. The length may be about 200 cm or less, 150 cm or less, about 120 cm or less, about 100 cm or less, about 90 cm or less, about 75 cm or less, about 60 cm or less, or about 50 cm or less. The length and the width of the light guide may be configured to direct light along a width of the light guide to distribute light to a region of interest, a blade, or both. The length may have a width and light may be directed out of the width along the length of the light guide.

The width may function to have a primary light directed from a first side along the width and light reflected from a second side along the width so that light is directed towards a predetermined location. The width may extend in a primary direction (e.g., a longest distance of a cross-section). Light may be primarily directed along the width and out one side of the width. One side of the width may be connected to a bridge, have light extend there through, or both. A second side of the width may have optics (e.g., a recess and prism) that direct light toward the first side.

The optics function to prevent hot spots, provide a homogenous light pattern, a homogenous distribution, amount, intensity, or a combination thereof of light, spread the light, prevent overlaps of light from light sources, direct light out of the light guide, or a combination thereof. The optics may provide a homogenous lighting appearance, on the article of manufacture, or both. The optics may be a texture added to the light guide. For example, a texture may be sprayed on the light guide, etched into the light guide, mechanically added, mechanically formed, added during molding, added during manufacturing, or a combination thereof. The optics may be on an external surface, an internal surface, a location between the internal surface and the external surface, or a combination thereof. The optics may be located within a recess, the blade, or both. The optics may guide light out of the light guide as the light travels through the light guide. The optics may guide light out of the blade in a first direction, a second direction, or both. The light guiding system may include one or more optics, two or more optics, or three or more optics. The optics may change a direction of the light. The optics may permit light to exit a surface (e.g., a first side) of the light guide. The optics may be formed while the light guides are being formed. Some light guides may include a texture portion on or in an external surface and an internal surface. The optics (e.g., micro-optics) may create an area where light exits the light guide. The optics may be a prism. The optics (e.g., prism) may have a shape that is a pyramid, half circle, square, rectangle, zig zag patterns, lines, cylindrical, tetrahedron, cube, hexagonal, icosahedron, a prism, a pentagonal pyramid, a cone, cuboid, a symmetrical shape, an asymmetrical shape, a geometric shape, a non-geometric shape, or a combination thereof. The optics may extend substantially a same length, a same width, or both as the light guide. The optics may include reflecting surfaces, redirecting surfaces, or both. The optics may be located on a second surface and direct light towards a second surface. The light may be directed by the optics through the first surface and into a bridge.

The bridge functions to connect a light guide to a blade. The bridge functions to form one monolithic piece that includes a light guide and a blade. The bridge functions to direct some light from the light guide to the blade. The bridge may extend a length of the light guide, the blade, or both. The bridge may extend from a center, top, or bottom of a light guide to a center, top, or bottom of a bridge. The bridge and blade may be coplanar. The bridge may be located below the blade. The bridge may extend above the blade. The bridge and blade may connect at any location so that blade and light guide are connected. The light guide and bridge may be connected at any location so that the light guide and blade guide light to a location of interest. The light guide, bridge, and blade may all be one monolithic part made of a singular monolithic material. Light may pass through the bridge, above the bridge, below the bridge, around the bridge, or a combination thereof. Light extending from the light guide to the blade may entirely bypass the bridge. Some light may extend through the bridge and some light may extend around the bridge into the blade.

The blade functions to light up, provide light, glow, direct light to a location, direct light around a location. The blade may be an area that is illuminated. The blade may emit light. The blade may light up an area or region. The blade may be a visible portion of the light guiding system. The blade may be an only portion of the light guiding system that is visible. The blade may provide light along an edge, a side, or both. The blade may project light out of an end. The blade may project some light and enlighten by glowing. The blade may have total internal reflection to direct light along the blade and then out an end of the blade. The blade may be straight. The blade may be curved or have a curve such that light moves through the blade and then out of the blade.

The curved region functions to change a shape of the blade. The curved region may vary a shape of a blade to mirror a shape of an article of manufacture. The curved region may mirror a shape of an interior component, an external component, or both. The curved region may change a shape of a blade from a first plane to a second plane. The first plane and the second plane may extend at an angle relative to one another. The angle may be about 90 degrees or more, about 105 degrees or more, about 135 degrees or more, about 150 degrees or more, about 160 degrees or more, or about 175 degrees or more. The angle may be about 270 degrees or less, 250 degrees or less, about 225 degrees or less, about 200 degrees or less, or even about 180 degrees or less. The angle may be about 90 degrees or less, about 75 degrees or less, about 60 degrees or less, about 45 degrees or less, or about 30 degrees or less. The angle may be about 5 degrees or more, about 15 degrees or more, about 25 degrees or more, or about 45 degrees or more (e.g., ±2 degrees). Light may be located within the curve (e.g., an area above over below the curve). The curve may provide light to a location under the curve so that light is directed from more than one direction. The curve region may provide light along a portion of a circumference, towards a pivot point, along a radius, in a radial direction, or a combination thereof. The curve region may enlighten a vehicle part along two planes. The curve region may be or include one or more curves (e.g., changes in direction). The curves may change a direction and/or shape of the blade along one or more planes, two or more planes, or three or more planes. The curves may be located opposite one or more funnels.

The funnels function to collect light, guide light into the blade, or both. The funnels may be located on a first side of a blade, a second side of a blade, or both. The funnels may extend outward from the blade at a location proximate to the bridge, the light guide or both. The funnels may change an angle of light extending into the blade. The funnels may direct light into the blade, along the blade, towards a wall of the blade, out of the blade, or a combination thereof. The angle of light extending into the blade may be different when the blade includes funnels then when the blade is free of funnels. Stated another way, an angle of light extending through the light blade may be smaller than an angle of light extending through a blade that is free of funnels. The funnels may change an angle of the light through the blade by an angle of about 5 degrees or more, about 10 degrees or more, or about 15 degrees or more. The funnels may change an angle of the light through the blade by an angle of about 30 degrees or less, about 25 degrees or less, or about 20 degrees or less. For example, if the light without a funnel had an angle of about 135 degrees then the light with funnels has an angle of about 105 degrees. Thus, the light extending out of the blade may be more condensed than light that extends out of a blade that is free of funnels. The funnels may extend outward a distance so that the blade and funnels have a shape that substantially mirror a height of the light guide. Stated another, way the height of the blade and the light guide may be substantially equal so that substantially all of the light extending out of the light guide towards the light blade is directed into the blade. The funnels may extend out 0.1 mm or more, about 0.2 mm or more, about 0.3 mm or more, or about 0.5 mm or more. The funnels may extend out about 5 mm or less, about 4 mm or less, about 3 mm or less, about 2 mm or less, or about 1 mm or less each. The funnels may taper as the funnels extend away from the bridge and the light guide. The funnels may increase a thickness of the blade. The funnels may create an offset that receives light. The offset may stagger the blade relative to the bridge.

The offset functions to connect the bade to one side of the blade, an edge of the blade, a location of the blade other than a center of the blade, on a side of the center of the blade. The Offset may stagger the bridge so that the bridge is located on an edge of a side so that light traveling out of the light guide into the blade is substantially free of traveling through the bridge. The offset may be an increase in thickness of the blade on one side of the bridge so that an air gap is located between the offset and the light guide. The offset may shift the bridge along the blade, the light guide, or both. The offset may create an offset funnel. The offset may create an air gap on a side of the blade where light extends out of the blade or opposite where the light extends out of the blade. The light guiding system may be in communication with one or more controllers that control light sources directed into the light guiding system.

The controllers function to control the light sources or the lights within a light source individually. The controller may be part of the vehicle, part of the light system, or both. A single controller may control all of the lights. The controller may illuminate (e.g., fire) the lights in a sequence, individually, in a pattern, a predetermined manner, a predetermined sequence, randomly, or a combination thereof. The controller may be programmable, include pre-set programs, or both. The controller may be accessed inside of the vehicle so that the user can change the illumination settings (e.g., colors, brightness, intensity) of the light system. The controller may communicate with light sources through one or more printed circuit boards.

The light sources (and lights) may be located on or connected to one or more printed circuit boards. The printed circuit boards (PCB) may provide power, signals, support, or a combination thereof to one or more light sources. The PCB may be fixed within a light system. Each PCB may be connected to a plurality of light sources. The PCB may be electrically connected, mechanically connected, or both to one or more light sources discussed herein. The PCBs may aim the light from the light sources. The PCBs may align a light source with a light guide.

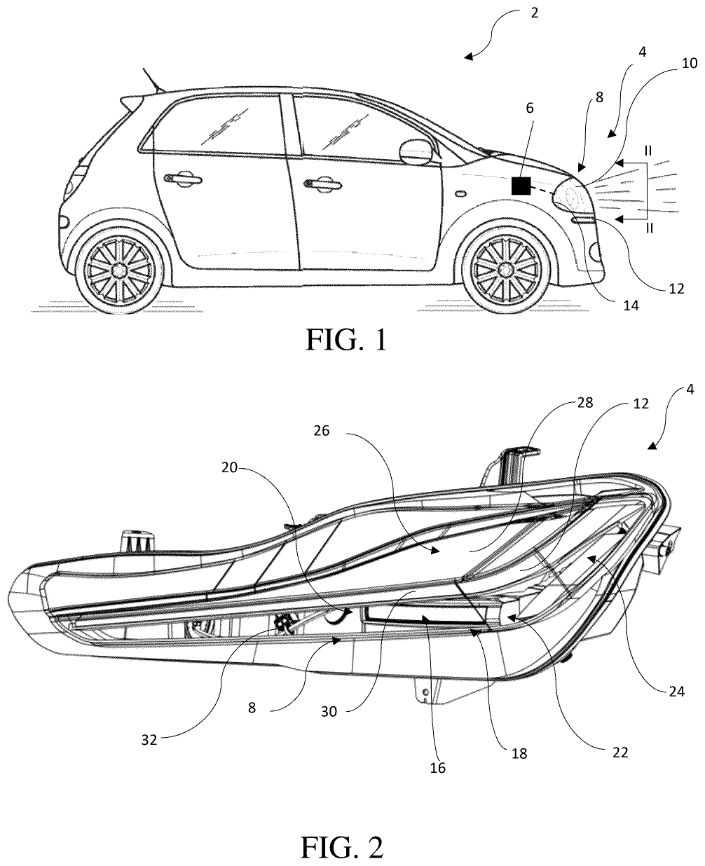

FIG. 1 illustrates a side view of a vehicle 2 including a light system 4. The light system 4 is in communication with a controller 6. The light system 4 includes a headlight 8 that is covered by an outer lens 10. The light system 4 also includes a daytime running light 12 and a turn signal 14.

FIG. 2 illustrates a front plan view of the light system 4 of FIG. 1 along line II-II. The light system 4 includes headlights 8 and a daytime running light 12. The headlights 8 have a high beam 16 and a low beam 18. The high beam 16 and the low beam 18 each include light sources 20 and reflectors 22. The daytime running light (DRL) 12 includes a daytime running light lens 24 (DRL lens). The light sources 20 are located behind a lens 26. The lens 26 includes a body portion 28 and a waterfall portion 30. A light guiding system 32 extends within the light system 4 to guide light to a side of the light system 4.

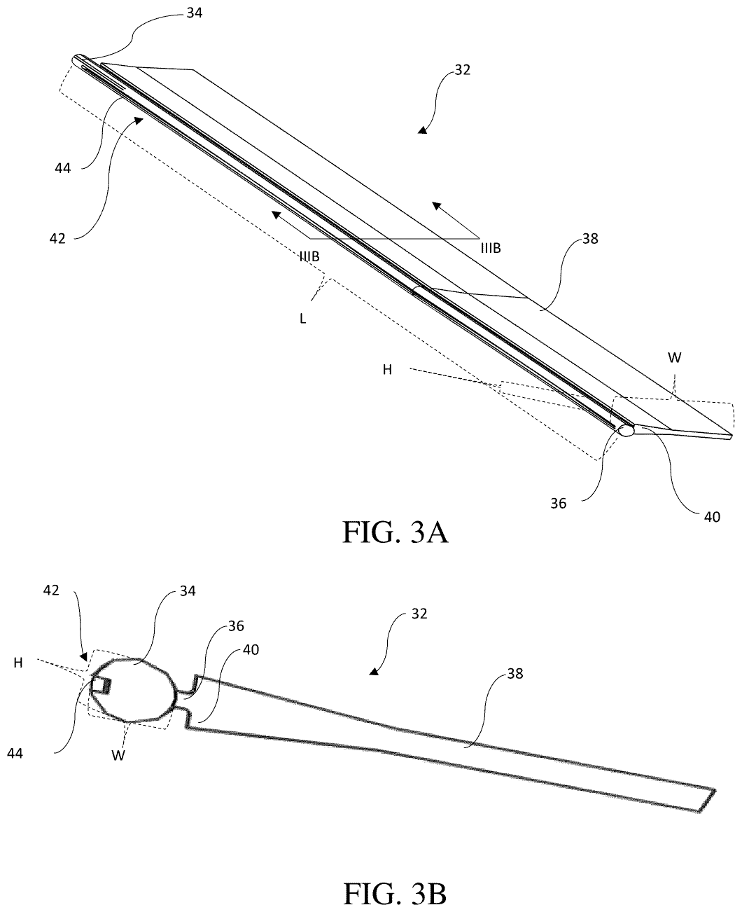

FIG. 3A is an isometric view of a light guiding system 32 (e.g., of FIG. 2). The light guiding system 32 has a length (L), width (W), and height (H). The light guiding system includes a light guide 34 with a bridge 36 that connects the light guide 34 to a blade 38. The blade includes a funnel 40 that matches a height of the light guide 34. The light guide 34 includes a recess 42 containing a prism 44 located opposite the bridge 36.

FIG. 3B is a cross-sectional view of the light guiding system 32 FIG. 3A along line IIIB-IIIB. The light guiding system 32 includes a light guide 34 that receives light. The light internally reflects along the length (L) and width (W) within the light guide 34 until the light contacts a prism 44 within a recess 42. The optics (shown as a prism 44) directs the light along the width (W) towards the bridge 36. The light passes from the light guide 34 into the blade 38. Some light extends through the bridge 36 and some light extends into the funnel 40 into the blade 38 so that the blade is illuminated. A height of the blade 38 at the funnels 40 is substantially equal to the height (H) of the light guide 34 so that substantially all of the light directed by the prism 44 horizontally extends into the blade 38.

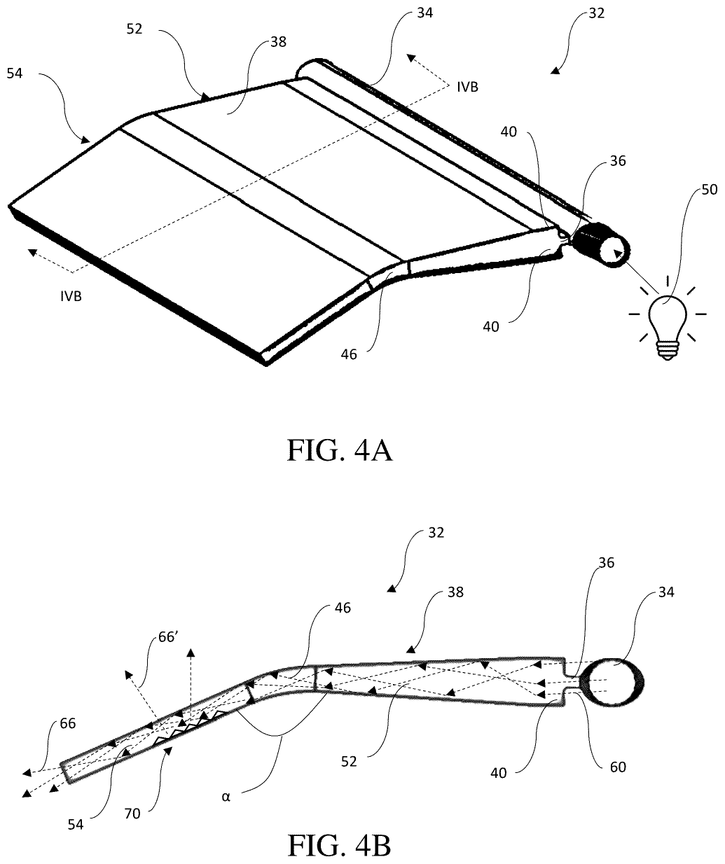

FIG. 4A is an isometric view of a light guiding system 32. A light source 50 directs light into a light guide 34 of the light guiding system 32. The light guide 34 distributes light along a length of the light guide 32. The light guide 32 then directs light into the blade 38 so that some light extends directly into the blade 38 and some light extends through a bridge 36 into the blade 38. The bridge 36 connects the light guide 34 to the blade 38. An end of the blade 38 connecting to the bridge 36 includes funnels 40 that collect light. The blade 38 includes a curve region 46 where the blade changes from extending in a first plane 52 to extending in a second plane 54.

FIG. 4B is a cross-sectional view of the light guiding system 32 of FIG. 4A along line IVB-IVB. As shown, light 60 is directed from the light guide 34 into the blade 38. The light 60 extending out of the light guide 34 extends into the blade 38 via the bridge 38 and funnels 40. The funnels 40 and blade 38 have a height that mirror a height of the light guide 34. The light 60 extends along a first plane 52 of the blade 38, through a curve region 46 and into a second plane 54 of the blade 38 that is angled relative to the first plane 52 an angle (a). As shown, light is internally reflected through the light guide 34 and blade 38. Some of the light extends out of an end of the blade 38 as direct light 66. The blade 38 includes optics 70 that direct light out of a side of the blade 38 as direct light 66′.

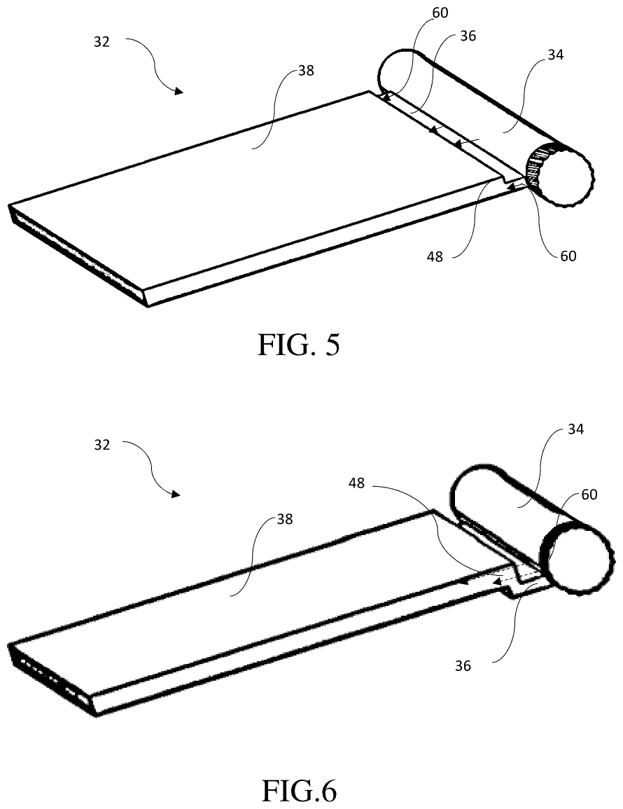

FIG. 5 is an isometric view of a light guiding system 32. The light guiding system 32 has a light guide 34 connected to a blade 38 by a bridge 36. The blade 38 includes an offset 48 (or offset funnel 48) so that the bridge 36 is located on one side of the light guide 34 and blade 38. Light 60 extends through the bridge 36 and entirely on one side of the bridge 36 into the offset 48 to enlighten and/or direct light through the blade 38. As shown, the offset 48 extends the blade 38 outward only on one side of the blade 38. The offset 48 assists in directing more light 60 into the blade 38. Stated another way, the offset 48 collects more of the light by the offset 48 extending the blade 38 into a path of light 60 extending out of the light guide 34.

FIG. 6 illustrates a light guiding system 32 with a bridge 36 that is connected to a bottom of a light guide 34 and a bottom of the blade 38. The blade 38 extends upward and has an offset 48 relative to the bridge 36 so that substantially all of the light 60 extends directly into the offset 48 of the blade 38. As shown, no light 60 extends into the blade 38 through the bridge 36. Stated another way, the bridge 36 connects to a bottom of the light guide 34 and a bottom of the blade 38 so that light is not directed between the light guide 34 and the blade 38 through the bridge 36.

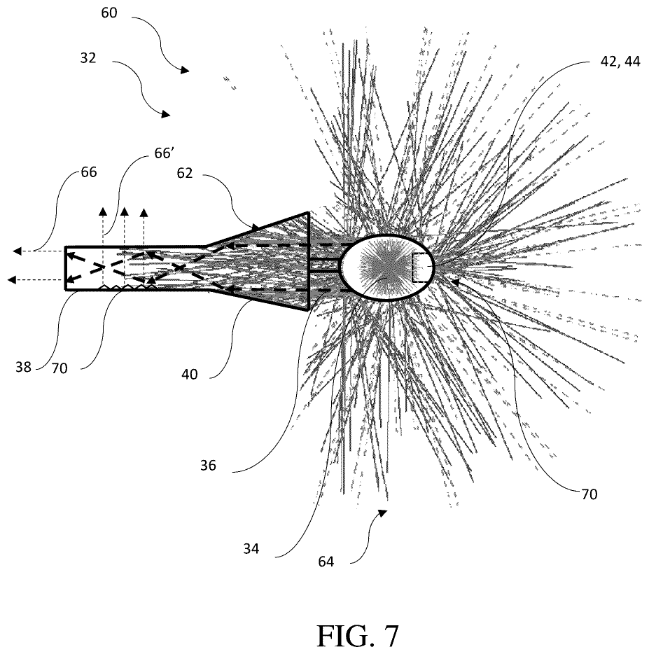

FIG. 7 is a cross-sectional view of light 60 passing out of the light guiding system 32. The light guiding system 32 has a light guide 34 that directs the light longitudinally. A shape of the light guide 33 has a bridge 36 on a first side and optics 70 on a second side that include a recess 42 and prism 44. The light 60 is directed along a primary light 62 towards that the first side of the light guide 34. Some light extends out of the light guide 34 as scattered light 64 (e.g., or secondary light). The primary light 62 is about 50 percent or more, 60 percent or more, or about 70 percent or more of the total light that exits the light guide 34 and extends into the blade 38. Thus, the scattered light 64 is about 50 percent or less, 40 percent or less, or about 30 percent or less of the total light that exits the light guide 34. The blade 38 includes funnels 40 on opposing sides that collect more of the primary light 62 so that an amount of scattered light 64 is reduced. The shape of the light guide 34 directs light in a direction of the blade 38 (e.g., as primary light) and out of the light guide 38 as directed light 66. The blade 38 may also include optics 70 that guide some of the directed light 66′ in a second direction.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of or even consists of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

### ELEMENT LIST

2 Vehicle
4 Light system
6 Controller
8 Headlight
10 Outer lens
12 Daytime running light
14 Turn signal.
16 High beam
18 Low beam
20 Light source
22 Reflector
24 Daytime running light lens
26 Lens
28 Body portion
30 Waterfall portion
32 Light guiding system
34 Light guide
36 Bridge
38 Blade
40 Funnel
42 Recess
44 Prism
46 Curve region
48 Offset Funnel
50 Light source
52 First Plane
54 Second Plane
60 Light
62 Primary light
64 Scattered light
66 Directed light

1. A light system comprising:
a light guiding system comprising:
a light guide configured to receive light and direct the light along a length, a width, or both of the light guide;
a blade configured to receive substantially all of the light from the light guide;
a bridge that connects the light guide and the blade together; and
one or more funnels that extend outward relative to the bridge to collect the light from the light guide that extends around the bridge so that the light is guided from the light guide into the blade.

2. The light system of claim 1, wherein the light guide, the blade, and the bridge are all one monolithic component.

3. (canceled)

4. The light system of claim 1, wherein the one or more funnels are two funnels and the two funnels extend outward from opposing sides of the blade.

5. The light system of claim 4, wherein the two funnels taper as the funnels extend away from the light guide.

6. The light system of claim 1, wherein the light guide has a cross-sectional shape that is substantially elliptical.

7. The light system of claim 1, wherein the bridge is connected to a center of the light guide and a center of the blade along a cross-section of the light guiding system.

8. The light system of claim 1, wherein the bridge is located directly opposite from optics.

9. A light system comprising:
a light guiding system comprising:
a light guide configured to receive light and direct the light therethrough;
a blade configured to receive substantially all of the light extending from the light guide, the blade comprising:
a bridge that connects the light guide to the blade and directs light into the blade; and
one or more funnels that are connected to the blade and extend outward relative to the bridge to collect the light from the light guide that extends around the bridge so that the light is guided from the light guide into the blade.

10. The light system of claim 9, wherein light guide has an elliptical cross-sectional shape.

11. The light system of claim 10, wherein the elliptical cross-sectional shape has a width greater than a height.

12. The light system of claim 10, wherein the bridge connects to a first side of the light guide and optics are located on a second side of the light guide opposite the optics so that the optics direct the light from the second side toward the first side.

13. The light system of claim 9, wherein the bridge connects to a bottom of the light guide and a bottom of the blade so that substantially the bridge is substantially free of light extending therethrough.

14. The light system of claim 9, wherein the light guide, the bridge, and the blade are all one monolithic part.

15. The light system of claim 9, wherein the one or more funnels extend out of opposing surfaces of the bridge to collect the light from the light guide.

16. A light system comprising:
a light guiding system comprising:
a light guide configured to receive light and direct the light therethrough;
a blade configured to receive substantially all of the light extending from the light guide;
a bridge that connects the light guide to the blade;
a first funnel on a first side of the blade that extend outward from the blade to collect the light from the light guide that extends around the bridge and direct the light into the blade, and
a second funnel on a second side of the blade that extends outward from the blade away from the first funnel to collect the light from the light guide that extends around the bridge and direct the light into the blade.

17. The light system of claim 16, wherein the first funnel and the second funnel tapers towards the blade as the first funnel and the second funnel extend away from the light guide.

18. The light system of claim 17, wherein the first funnel and the second funnel have a triangular cross-sectional shape.

19. The light system of claim 16, wherein the blade includes a curve region that changes an angle of the blade.

20. The light system of claim 19, wherein angle is about 90 degrees or more and about 180 degrees or less.

21. The light system of claim 1, wherein light extends above the bridge, below the bridge, or both into the blade so that the blade is illuminated by the light.
